(19) United States
(12) Patent Application Publication
(10) Pub. No.: US 2013/0100275 A1
(43) Pub. Date: Apr. 25, 2013

(54) APPARATUS AND METHOD TO ESTIMATE THE POTENTIAL EFFICIENCY OF A POLYCRYSTALLINE SOLAR CELL

(71) Applicants: Johan DeGreeve, Brabant (BE); Kristiaan VanRossen, Bierbeek (BE)

(72) Inventors: Johan DeGreeve, Brabant (BE); Kristiaan VanRossen, Bierbeek (BE)

(73) Assignee: KLA-TENCOR CORPORATION, Milpitas, CA (US)

(21) Appl. No.: 13/577,374

(22) PCT Filed: Jul. 25, 2012
(86) PCT No.: PCT/IB12/53776

§ 371 Date: Aug. 6, 2012

Related U.S. Application Data
(60) Provisional application No. 61/515,086, filed on Aug. 4, 2011.
(60) Provisional application No. 61/623,561, filed on Apr. 13, 2012.

(51) Int. Cl. G06T 7/00

(52) U.S. Cl. CPC G06T 7/0004
USPC 348/87; 382/145

(57) ABSTRACT

A method for estimating the efficiency of a solar cell to be manufactured from a wafer is disclosed, wherein the efficiency estimate is obtained from a density of crystallite boundaries on a surface of the wafer. In embodiments the density of crystallite boundaries is obtained from a digital image of the surface of the wafer, from which first a filtered image, and then a binary image is generated. The binary image is evaluated to obtain the density of crystallite boundaries. Alternatively, the efficiency estimate is obtained from the sizes of crystallites on the surface of the wafer. An apparatus for obtaining the efficiency estimate is also disclosed.

### CROSS REFERENCE TO RELATED APPLICATIONS

This patent application claims priority of U.S. provisional patent application No. 61/515,086 filed Aug. 4, 2011, and of U.S. provisional patent application No. 61/623,561 filed Apr. 13, 2012; the applications are incorporated herein by reference.

### FIELD OF THE INVENTION

The present invention relates to methods for estimating an efficiency of a solar cell to be manufactured from a wafer during a production process.

The present invention also relates to an apparatus for estimating an efficiency of a solar cell to be manufactured from a wafer during a production process.

### BACKGROUND OF THE INVENTION

An important parameter for characterizing solar cells is the efficiency, which is the percentage of the received light energy that is converted to electrical energy. The higher the efficiency of a solar cell, the more electrical energy per surface area of the solar cell is delivered. The efficiency of a solar cell depends on various parameters, like for example the percentage of the front surface area covered by front contacts, the thickness of the cell, or the quality of the antireflective coating. An important parameter with an impact on the efficiency of a solar cell is the base material the solar cell is made from. Such material is provided in the form of wafers, which in turn have been obtained by sawing from an ingot. Solar cells manufactured from a monocrystalline wafer have a higher efficiency than solar cells made from polycrystalline wafers. Amongst the polycrystalline wafers are wafers which exhibit relatively few crystallite boundaries, and therefore may be referred to as mono-like wafers, in contrast to polycrystalline wafers exhibiting a larger number of crystallite boundaries. The efficiency of a solar cell depends on the number of crystallite boundaries in the wafer the solar cell is made from.

The German patent application DE 199 14 115 A1 discloses a method and a system for the analysis of flaws in polycrystalline wafers, solar cells, and solar modules, in particular for determining the mechanical tension due to processing and structure of the wafer. An image of the surface of the wafer is recorded and processed to obtain characteristics like the alignment of crystallites, grain boundaries, or distribution of centers of areas and sizes of areas. Electrical and mechanical characteristics of the solar cells are also recorded, like power, short-circuit current, vibration modes. This information is used as input data for training a neural network, which is to be used for classifying wafers, solar cells, and solar modules into groups of different quality.

The German patent application DE 10 2007 010 516 A1 describes a method and an apparatus for identifying a polycrystalline product like a solar module at various stages of its manufacture. An image of the product is compared with reference images by image processing, with the aim of comparing the polycrystalline structures depicted in the image of the product and the reference images. Finding identical or at least similar characteristic polycrystalline structures in the image of the product and reference images allows to identify a product. In this way process parameters of a multi-stage manufacturing process can be related to an end product like a solar module and can be evaluated for improving quality.

The efficiency of solar cells can of course be measured once the solar cell has been produced. If the quality of a specific polycrystalline wafer from which a solar cell is made is low, the efficiency of the resulting solar cell will be low, possibly too low, in which case the effort that went into the production of this solar cell has been wasted. A method like in DE 199 14 115 A1 also requires finished solar cells and involves complex training of a neural network. In DE 10 2007 010 516 A1, wafers/solar cells are followed through the entire production process.

There are also photoluminescence based methods that may be applied to raw solar wafers to get a measure of the efficiency. However, these methods only provide reliable results on wafers where saw damages are already removed. That means photoluminescence cannot be used for incoming inspection. Furthermore, these methods require costly inspection tools, and are too time consuming for production environments.

### SUMMARY OF THE INVENTION

It is an object of the invention to provide a simple method for quickly and reliably estimating an efficiency of a solar cell to be manufactured from a wafer during a production process.

The object is achieved by a method comprising the following steps:
identifying crystallite boundaries on a surface of the wafer;
deriving a density of crystallite boundaries on the surface of the wafer;
obtaining an efficiency estimate from the density of crystallite boundaries.

It is also an object of the present invention to provide an additional method for quickly and reliably estimating an efficiency of a solar cell to be manufactured from a wafer during a production process.

This object is achieved by a method comprising the following steps:
identifying crystallites on a surface of the wafer;
determining a size for each identified crystallite, thus generating a list of sizes;
obtaining an efficiency estimate of the solar cell as a function of the list of sizes determined in the previous step.

It is a further object of the invention to provide an apparatus for quickly and reliably estimating an efficiency of a solar cell to be manufactured from a wafer during a production process.

The object is achieved by an apparatus comprising:
a camera configured to capture an image of the surface of the wafer, wherein the camera defines an imaging path;
an illumination system configured to illuminate the surface of the wafer, wherein the illumination system is arranged coaxial to the imaging path;
an image processing unit, configured to process an image of the surface of the wafer captured by the camera, and to derive an efficiency estimate for a solar cell to be manufactured from the wafer from the image.

The efficiency of a solar cell depends on the polycrystalline structure of the wafer from which the solar cell is to be produced. An estimate of this efficiency can be obtained from information on the crystallite boundaries. On the surface of a wafer, these crystallite boundaries are visible and can be identified. According to the invention, the estimate of the efficiency of the solar cell is obtained from the density of crystallite boundaries on the surface of the wafer. The method can be applied at any stage of the production process of the solar cell where the surface of the wafer is visible; in particular the method can be applied to the raw wafer as obtained, for example, by sawing from an ingot.

The density of the crystallite boundaries can be expressed in various ways. In embodiments of the method, this density may be expressed as the number of boundaries per unit area, or as the total length of crystallite boundaries per unit area. A numerical value for the density of the crystallite boundaries obtained in such a way is used to estimate the efficiency of the solar cell.

In the simplest case, only a distinction between high-efficiency and low-efficiency wafers is desired. The density of crystallite boundaries for the surface of a given wafer is compared with a density threshold, and the wafer is classified as a low-efficiency wafer, if the density of crystallite boundaries is above the density threshold, and is classified as a high-efficiency wafer, if the density of crystallite boundaries is below the density threshold. The density threshold may be directly specified by a user. The density threshold may also be obtained by some form of analysis, for example statistical analysis. If, for example, it is desired to identify wafers from which solar cells can be produced with an efficiency at least equal to or above a specified efficiency level, a statistical analysis may lead to a density threshold such that wafers capable of achieving or surpassing the specified efficiency level exhibit a density of crystallite boundaries which is below this density threshold with a chosen statistical reliability. For instance, a user might be interested in identifying a density threshold such that wafers from which solar cells with an efficiency of at least 16% can be produced have a density of crystallite boundaries below this density threshold with a probability of 95%. Performing a statistical analysis of density values of plural wafers and corresponding efficiencies of solar cells produced from the wafers can identify such a density threshold.

In another embodiment, a look-up table relating solar cell efficiency values with densities of crystallite boundaries has been pre-generated, and an efficiency estimate for a given wafer can be obtained by determining the density of crystallite boundaries of a surface of the wafer and finding a corresponding efficiency value from the look-up table. As a look-up table only holds discrete values, an interpolation may be performed of the values of the look-up table to obtain an efficiency estimate for the density value of the given wafer. Alternatively, the efficiency value corresponding to the density value in the look-up table which is closest to the density value determined for the given wafer may be accepted as an efficiency estimate for the given wafer.

In a further embodiment, a value for the efficiency may be calculated from a value for the density of crystallite boundaries with a polynomial function. Such a polynomial function can for example be obtained by interpolation of a sample set of pairs, each pair consisting of a density value of crystallite boundaries and a corresponding value of the efficiency of the solar cell. Several interpolation techniques are known to the person skilled in the art; polynomial functions may in particular be obtained by, for example, the Lagrange interpolating polynomial or splines, especially cubic splines.

For identifying the crystallite boundaries on the surface of a wafer, in embodiments of the method a digital image of the surface of the wafer is taken. Such a digital image may for example be generated by an area or line scan camera. The digital image then is processed to extract information on the crystallite boundaries from the image.

From the digital image in embodiments a filtered image is produced by applying a gradient or variance filter to the digital image. The crystallite boundaries will exhibit pronounced variations of the pixel values (grayscale or colour) in the digital image, and correspondingly pronounced gradients of the pixel values, in comparison with the interior areas of individual crystallites. A gradient or variance filter will localize locations in the image with pronounced variance, or gradient, respectively, of the pixel values, and therefore is a step towards identifying crystallite boundaries in the image.

The filtered image in embodiments is then subject to a binarization procedure, producing a binary image. In this binarization procedure the values of a plurality of pixels of the filtered image, possibly of all pixels of the filtered image, are compared with a binarization threshold. For each pixel of the filtered image considered, a first value is assigned to a corresponding pixel of the binary image, if the value of the respective pixel in the filtered image is above the binarization threshold; otherwise a second value is assigned to the corresponding pixel of the binary image. The pixels of the binary image having the first value represent the crystallite boundaries on the surface of the wafer the image of which has been taken.

From the binary image the density of crystallite boundaries can be obtained. As the binary image is composed of pixels, the density of crystallite boundaries may, in addition to the possibilities mentioned above, also be expressed as a ratio of the number of pixels in the binary image having the first value and the total number of pixels representing the surface of the wafer in the binary image.

It should be clear that, in whatever way an estimate for the efficiency of a solar cell is obtained from the density of crystallite boundaries on the surface of a wafer from which the solar cell is to be manufactured, such an estimate only is valid for one specific type of solar cell, of course. For example, if two identical wafers, which in particular also exhibit the same density of crystallite boundaries, are taken, and two solar cells are produced therefrom, which differ, for example in the antireflective coating and/or the front contacts, then these solar cells will typically have different efficiencies. This difference between these two types of solar cells needs to be taken into account when estimating the efficiency of a solar cell from the wafer it is to be made from. With regard to the methods described above for obtaining such an estimate, this means for example that for the same minimum efficiency level two different density thresholds are required, or that two different look-up tables need to be pre-generated, or that two different polynomial functions are needed for the two different types of solar cell.

Furthermore it should be clear that density thresholds, look-up tables, and polynomial functions are only valid for a specific way of expressing the density of crystallite boundaries. If, for example, the density of crystallite boundaries in a first case is expressed as the total length of crystallite boundaries per unit area, and in a second case as the ratio of the number of pixels in the binary image having the first value and the total number of pixels representing the surface of the wafer in the binary image, then the density thresholds for a given level of efficiency, the look-up tables, and the polynomial functions corresponding to the two cases will respectively differ.

In embodiments of the method, in order to take a digital image of the surface of the wafer, the surface of the wafer is illuminated with light from an illumination system. Light from the surface is then directed along an imaging path to a camera, where a digital image of the surface of the wafer is generated. According to this embodiment of the method, the imaging path and the illumination system are coaxial. Therein, in embodiments, light from the illumination system encloses an angle of 0 degrees to 30 degrees, and preferentially from 10 degrees to 20 degrees, with a normal of the surface of the wafer.

A further method according to the invention for estimating an efficiency of a solar cell to be manufactured from a wafer during a production process starts by identifying crystallites on the surface of the wafer. For each crystallite identified, the size is determined. A list of sizes of identified crystallites results. An estimate of the solar cell efficiency is obtained as a function of the list of sizes. Size of a crystallite here means a size of the crystallite as is visible on the surface of the wafer. When cutting the wafer from an ingot, crystallites in the ingot are cut, too, which results in a new surface of a cut crystallite on the surface of the wafer. The size of the crystallite is understood as the size of this surface of the crystallite at the surface of the wafer.

In embodiments, the function of the list of sizes is a function of the sum of the sizes in the list.

In embodiments the crystallites identified and used for further evaluation are a set of a number N of largest crystallites. The number N can be set by a user or determined automatically by selecting all crystallites larger than a predefined absolute size or a set percentage of the total wafer size.

In embodiments the crystallites are identified and their sizes determined by first taking a digital image of the surface of the wafer, and then determining for each identified crystallite the number of pixels representing the crystallite in the digital image. This number of pixels is a direct measure of the size of the respective crystallite. In a specific embodiment, in order to take a digital image of the surface of the wafer, the surface of the wafer is illuminated with light from an illumination system, wherein the illumination system is coaxial with an imaging path of a camera configured to record the digital image of the surface of the wafer. As in the method based on crystallite boundaries, in embodiments light from the illumination system encloses an angle of 0 degrees to 30 degrees, and preferably of 10 degrees to 20 degrees with a normal of the surface of the wafer.

In embodiments the illumination system comprises plural light sources which are activated simultaneously in order to record a digital image of the surface of the wafer. In different embodiments of the method the illumination system comprises plural light sources, the light sources are activated as a function of time in a sequence of predefined patterns, and a digital image is recorded for at least one predefined pattern of activated light sources. In specific embodiments the illumination system comprises four groups of light sources, each group of light sources contains at least one light source, the groups are aligned such that each group corresponds to one side of a rectangular area parallel to the surface of the wafer, and the sequence of predefined patterns is such that the groups of light sources are activated successively. The various options for activating the light sources just mentioned, i.e. simultaneous activation or activation in a sequence of predefined patterns, are of course also available for the method discussed above which bases the efficiency estimate on crystallite boundaries.

A gradient or a variance filter can be applied to each recorded digital image.

In embodiments, a digital image is recorded for each of a plurality of the patterns of activated light sources mentioned above, and the digital images are combined into a single resulting image by data processing. In particular, a gradient or a variance filter may be applied to each recorded digital image, thus generating a filtered image for each recorded digital image. In specific embodiments the filtered images are combined into a single resulting image by assigning to each pixel of the resulting image the maximum of the values of the corresponding pixels in the filtered images; the corresponding pixels of the filtered images are those pixels that represent the same spot on the surface of the wafer in the various filtered images as the respective pixel in the resulting image. Alternatively, the resulting image may be generated by a pixel-wise sum or average of the filtered images.

In any case, when generating the resulting image from the filtered images, inhomogeneities of the illumination may be taken into account. These inhomogeneities can for example be determined by placing a photodetector at the location occupied by a wafer during the generation of an efficiency estimate or by placing a reference gray card at the wafer position and recording an image with the camera. From the output of the photodetector or from the image recorded with the camera, the inhomogeneity of the illumination can be obtained. Based on the inhomogeneity distribution a distribution of weights for the pixel values in the individual filtered images can be derived, which is taken into account when calculating the resulting image from the filtered images.

In embodiments of the method only crystallites are taken into account which exhibit surfaces oriented according to the <100> Miller index within a predefined tolerance at the surface of the wafer, i.e. crystallites where the crystallite surface created by cutting the wafer from an ingot corresponds to the <100> surface within a predefined tolerance. Crystallites complying with this condition may for example be identified by means of the illumination system and the camera, exploiting the reflection characteristics of the surface of crystallites oriented according to the <100> Miller index.

The relevance of surfaces oriented according to the <100> Miller index is that if anisotropic etching is applied to such a surface for the purpose of roughening of the surface of the wafer, pyramid structures are created on the surface. The purpose of roughening is to reduce the reflectivity of the surface of the wafer. For pyramid structures, due to inter-reflection of light between faces of neighboring pyramids, each such reflection also involving absorption of some light energy and its conversion to electrical energy, the net reflectivity of the wafer surface is reduced and the efficiency of a solar cell manufactured from the wafer thus is increased.

In a specific embodiment a gray value for the largest crystallite oriented according to the <100> Miller index within a predefined tolerance at the surface of the wafer is determined and all further crystallites with a gray value within 15%, and preferably within 3%, of the total gray range available of the gray value for the largest crystallite are taken into account. Usually the gray range available extends from fully black to fully white; this may be expressed numerically in various ways and correspond, for example, to a range from 0 to 1, or, in particular for digital image processing, from 0 to 255, for an 8 bit color depth.

Alternatively, the crystallites to be taken into account are identified by determining a number K of crystallites with the lowest gray values, identifying the largest crystallite of these K crystallites and identifying its gray level G as the average or median gray value of its surface, and taking into account all crystallites with a gray value within a tolerance ΔG from the gray level G of the identified largest crystallite, wherein the tolerance ΔG is 15%, and preferably 3%, of the total gray level range possible. The value of K may be set by a user or determined automatically by selecting all crystallites with a gray level below a predefined gray level.

In embodiments, when selecting crystallites exhibiting a surface oriented according to the <100> Miller index within a predefined tolerance at the surface of the wafer, if a connected pair of such crystallites is encountered, one member of the pair is disregarded. The disregarded member may be the smaller or the brighter member of the pair. Connectedness of crystallites can be determined in various ways. For example, in a digital image of the surface of the wafer, two crystallites can be considered connected if the boundaries of the crystallites as they appear in the digital image have a number of pixels in common which is above a predefined threshold. This threshold may be zero, or can be chosen, for example, as a percentage of the length of the boundaries of the crystallites, for example of the boundary of the smaller of the two crystallites. Two crystallites may also be considered connected for the above purpose of disregarding one of them, if their boundaries do not have pixels in common, but there are pixels in the boundary of one crystallite which exhibit a distance to some pixels in the boundary of the other of the two, which is below a predefined distance threshold. Determining connectedness of crystallites can be done by iterative algorithms, for example for an input list of crystallites sorted by size by steps where the largest crystallite of the input list is selected, all crystallites connected to the largest crystallite are determined and removed from the input list, then the largest crystallite is moved from the input list to an output list, and then the aforementioned steps are repeated with the thus shortened input list, until the input list is empty. The result is an output list of crystallites not connected to each other according to the definition of connectedness employed in the iterative algorithm, for example one of the definitions given above.

In embodiments of the method, the sizes of crystallites which exhibit surfaces oriented according to the <100> Miller index within a predefined tolerance at the surface of the wafer are determined separately from the sizes of crystallites with different orientation. Additionally or alternatively a density of crystallite boundaries is determined in addition to a determination of the sizes of the crystallites. In these embodiments an efficiency estimate of the solar cell is obtained as a function of the data thus determined, i.e. as a function of the crystallite sizes, the density of crystallite boundaries, if determined, and the sizes of crystallites which exhibit surfaces oriented according to the <100> Miller index within a predefined tolerance at the surface of the wafer, if these sizes have been determined separately from the sizes of other crystallites. Densities of crystallite boundaries can be determined for example as described above in the context of the method based on crystallite boundaries.

A specific embodiment of the method for estimating an efficiency of a solar cell to be manufactured from a wafer during a production process comprises the steps of identifying a first group of crystallites, where the first group comprises crystallites with crystallite surfaces oriented according to the <100> Miller index within a predefined tolerance at the wafer surface, and a second group of crystallites, where the second group comprises crystallites with crystallite surfaces not oriented according to the <100> Miller index within the predefined tolerance at the wafer surface; deriving an area of the crystallite surfaces of the crystallites in the first group or in the second group; and obtaining an efficiency estimate from the area derived in the previous step.

The efficiency estimate for the solar cell in embodiments is obtained from a look-up table. The look-up table is pre-generated from a sample set of solar cell efficiency values and corresponding lists of sizes. In a specific embodiment, the look-up table relates efficiency values with the sum of the sizes in the corresponding list of sizes. In a different embodiment, the look-up table relates lists of sizes to efficiency values, i.e. no summation of the size values in the list is done. As in the case of look-up tables based on the density of crystallite boundaries described above, in order to obtain an efficiency estimate from the look-up table, an interpolation may be used. Alternatively, the value of the sum of sizes, or the list of sizes, respectively, in the look-up table which is closest to the sum of sizes or list of sizes, respectively, for a surface of a given wafer, may be used to obtain an efficiency estimate from the look-up table. In the case of a look-up table based on lists of sizes, the list of sizes closest to the list of sizes for a surface of a given wafer may for example be determined by considering the lists to be compared as vectors, taking the difference vector, and selecting the list from the look-up table yielding the difference vector of minimal length with the list of sizes for a surface of the given wafer.

In a different embodiment, the efficiency estimate is calculated from the list of sizes by a polynomial function. The polynomial function is derived from a sample set of solar cell efficiency values and corresponding lists of sizes. In a specific embodiment, the polynomial function depends on as many variables as there are elements in the list of sizes. In an alternative embodiment, the polynomial function depends on only one variable, and the sum of the sizes in the list of sizes is used as a value for this variable.

The apparatus according to the invention for estimating an efficiency of a solar cell to be manufactured from a wafer during a production process has a camera configured to capture an image of the surface of the wafer, and an illumination system configured to illuminate the surface of the wafer. The camera defines an imaging path and the illumination system is arranged coaxial to the imaging path. The apparatus also has an image processing unit, configured to process an image of the surface of the wafer captured by the camera and to derive an efficiency estimate for a solar cell to be manufactured from the wafer from the image.

In an embodiment, the illumination system includes a ring light illuminator. The ring light illuminator may be realised in various ways. For example, a plurality of light sources can be arranged in an annular fashion. Therein each light source is configured to emit a cone of light towards at least a part of the surface of the wafer to be illuminated. Alternatively, the ring light illuminator exhibits a continuous light emitting surface shaped as a ring. Of course, combinations of the possibilities mentioned may also be used.

In a different embodiment the illumination system has plural LED bars as light sources. In a specific embodiment, the illumination system has four LED bars, which are arranged in such a way that they include a rectangular area between them. Such an embodiment is particularly preferred, as the wafers used for the manufacture of solar cells typically are of rectangular shape, often square. For taking an image of the surface of the wafer the rectangular area between the LED bars preferentially is aligned such that for each side of the surface of the wafer there is one LED bar parallel to it.

The apparatus may furthermore exhibit an aperture plate with a rectangular aperture. The four LED bars here are arranged around the aperture on a side of the aperture plate facing away from the camera. For each side of the rectangular aperture there is one LED bar aligned parallel to it. For taking an image of the surface of a rectangular wafer the rectangular aperture preferentially is aligned such that for each side of the wafer there is one side of the aperture parallel to it.

To the apparatus there may also correspond a set of aperture plates, each aperture plate having an aperture which differs in shape and/or size from the apertures of the other aperture plates. The illumination system advantageously is adapted to the respective apertures, and preferentially arranged around the aperture on a side of the aperture plate facing away from the camera. In particular, the shape of the illumination system may be adapted to the shape of the aperture, so that for instance in the case of a circular aperture a ring light illuminator is used in the illumination system. For taking an image of a surface of a wafer, an aperture plate from the set of apertures may be used which exhibits an aperture adapted in shape to the wafer.

In an embodiment of the invention the apparatus for estimating an efficiency of a solar cell to be manufactured from a wafer during a production process exhibits a digital camera configured to capture an image of the surface of the wafer. The camera defines an imaging path. The apparatus furthermore has four LED bars are arranged and configured to illuminate the surface of the wafer. The LED bars are arranged on an aperture plate coaxial to the imaging path. The apparatus also has an image processing unit, configured to process an image of the surface of the wafer captured by the camera and to derive an efficiency estimate for a solar cell to be manufactured from the wafer from the image. In a specific embodiment the aperture plate has a rectangular aperture adapted in shape to a rectangular wafer to be imaged by the camera, wherein the LED bars are positioned around the aperture so that the LED bars face away from the camera and are parallel to each edge of the wafer.

### BRIEF DESCRIPTION OF THE DRAWINGS

The nature and mode of operation of the present invention will now be more fully described in the following detailed description of the invention taken with the accompanying drawing figures, in which

FIG. 1 is a schematic representation of the apparatus according to the invention for estimating an efficiency of a solar cell.

FIG. 2 is a schematic representation of an aperture plate with LED bars.

FIG. 3 is an image of the surface of a polycrystalline wafer.

FIG. 4 is an image of the surface of a polycrystalline “mono-like” wafer.

FIG. 5 is a schematic representation of the surface of a wafer showing crystallites and crystallite boundaries.

FIG. 6 is a diagram of densities of crystallite boundaries.

FIG. 7 shows a sequence of digital image, filtered image, and binary image for a polycrystalline wafer.

FIG. 8 shows a sequence of digital image, filtered image, and binary image for a mono-like wafer.

FIG. 9 illustrates the binarization procedure.

FIG. 10 shows two diagrams illustrating the binarization procedure.

FIG. 11 is a schematic representation of an aperture plate with a ring light illuminator.

FIG. 12 is a schematic representation of an aperture plate with another type of ring light illuminator.

FIG. 13 shows an aperture plate with light sources and light cones incident on the wafer surface.

### DETAILED DESCRIPTION OF THE INVENTION

Same reference numerals refer to same elements throughout the various figures. Furthermore, only reference numerals necessary for the description of the respective figure are shown in the figures. The shown embodiments represent only examples of how the invention can be carried out. This should not be regarded as limiting the invention.

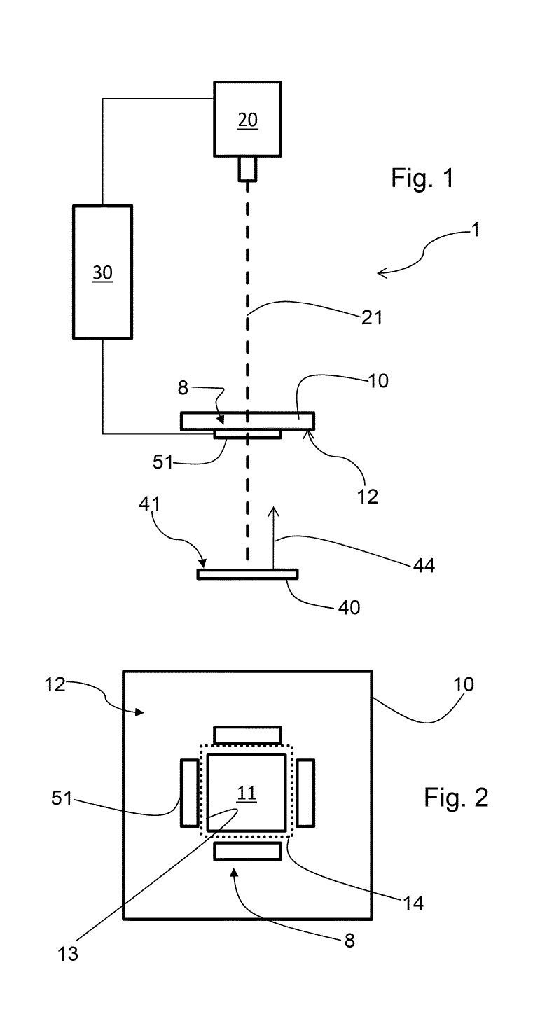

FIG. 1 is a schematic representation of the apparatus 1 according to the invention for estimating an efficiency of a solar cell from a wafer 40 the solar cell is to be produced from. The apparatus 1 has a camera 20 configured to capture an image of a surface 41 of the wafer 40. The camera 20 defines an imaging path 21. The imaging path 21 is essentially parallel to a normal 44 of the surface 41 of the wafer 40. The apparatus 1 furthermore has an image processing unit 30, which is configured to process an image recorded by the camera 20 and to obtain an efficiency estimate from the image. The image processing unit 30 in the embodiment shown furthermore controls both the camera 30 and an illumination system 8, which here comprises LED (light emitting diode) bars 51. Here the apparatus 1 also exhibits an aperture plate 10, and the LED bars 51 are arranged on a surface or side 12 of the aperture plate 10 facing away from the camera 20. The aperture plate 10 is part of the illumination system 8 and the illumination system 8 is arranged coaxial to the imaging path 21.

FIG. 2 is a schematic representation of the illumination system 8 with the aperture plate 10 shown in FIG. 1. Shown is the surface or side 12 of the aperture plate 10 facing away from the camera 1 in FIG. 1. Four LED bars 51 are arranged in such a way that they include a rectangular area 14 between them. In the embodiment shown, the rectangular area 14 contains a square aperture 11, around which the four LED bars 51 are arranged in such a way that each LED bar 51 is parallel to one side 13 of the aperture 11. In specific embodiments of the method according to the invention, these four LED bars 51 are activated successively, such that at each instant of time at most one LED bar 51 is activated, and for each activated LED bar 51 a digital image of the surface 41 (see FIG. 1) of the wafer 40 (see FIG. 1) is recorded, as has been discussed above.

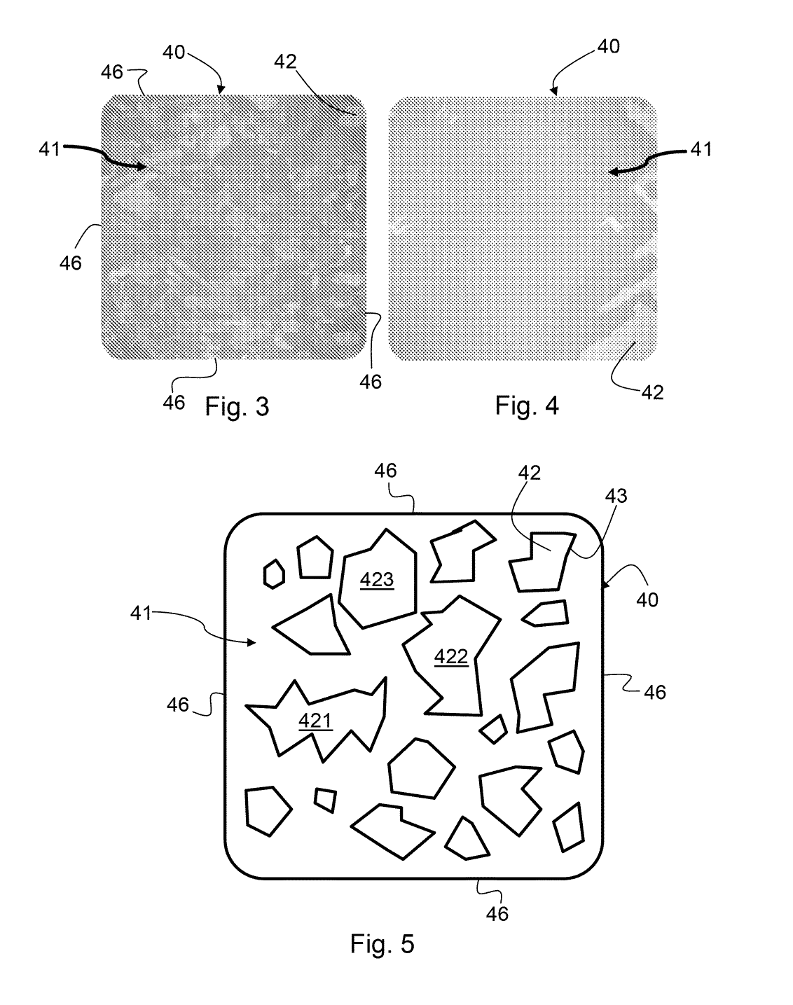

FIG. 3 shows a surface 41 of a wafer 40. The wafer 40 is a polycrystalline wafer, and on its surface 41 many crystallites 42 are visible. In the embodiment shown in FIG. 3 and FIG. 4 the wafer 40 is of an essentially rectangular shape. Consequently, the wafer 40 has four edges 46 enclosing the surface 41 of the wafer 40.

FIG. 4 also shows a surface 41 of a wafer 40. The wafer 40 shown is also a polycrystalline wafer, but in contrast to the wafer 40 shown in FIG. 3, relatively few crystallites 42 are visible on the surface 41 of the wafer 40 shown in FIG. 4. Polycrystalline wafers of this type, i.e. with few crystallites 42, are often referred to as “mono-like” wafers 40, as they are “almost” like monocrystalline wafers 40; for distinction, wafers of the type shown in FIG. 3 then are referred to as “real” polycrystalline wafers 40. A solar cell manufactured from a “mono-like” wafer 40, all other conditions being equal, has a higher efficiency than a solar cell manufactured from a “real” polycrystalline wafer 40.

FIG. 5 is a schematic drawing of a surface 41 of a wafer 40. The wafer 40 is of rectangular shape and is bordered by four edges 46. On the surface 41 many crystallites 42 are visible; each crystallite 42 is delimited by a crystallite boundary 43. Strictly speaking, a crystallite 42 is a three-dimensional object, and what is visible on the surface 41 of the wafer 40 is a surface created from the crystallite by the manufacturing process of the wafer 40, in particular by sawing the wafer 40 from an ingot, which entails sawing through crystallites in the ingot, wherein the surface of the crystallite 42 visible on and forming part of the surface 41 of the wafer 40 is created.

Also shown in FIG. 5 is a number, here three, of crystallites 421, 422, and 423, distinguished here for being the three largest crystallites on the surface 41 of the wafer 40. A number of largest crystallites is used in one embodiment of a method according to the invention for obtaining an estimate of the efficiency of a solar cell produced from the respective wafer, as has been described above. This embodiment uses the sizes of the largest crystallites, here three, 421, 422, and 423, to arrive at an estimate of the efficiency. The size of a crystallite here refers to the size of the area of the respective crystallite visible on the surface 41 of the wafer 40 examined. In another method according to the invention, the density of crystallite boundaries 43 is used to obtain an efficiency estimate of a solar cell to be produced from the wafer 40 examined. This method also has already been discussed above.

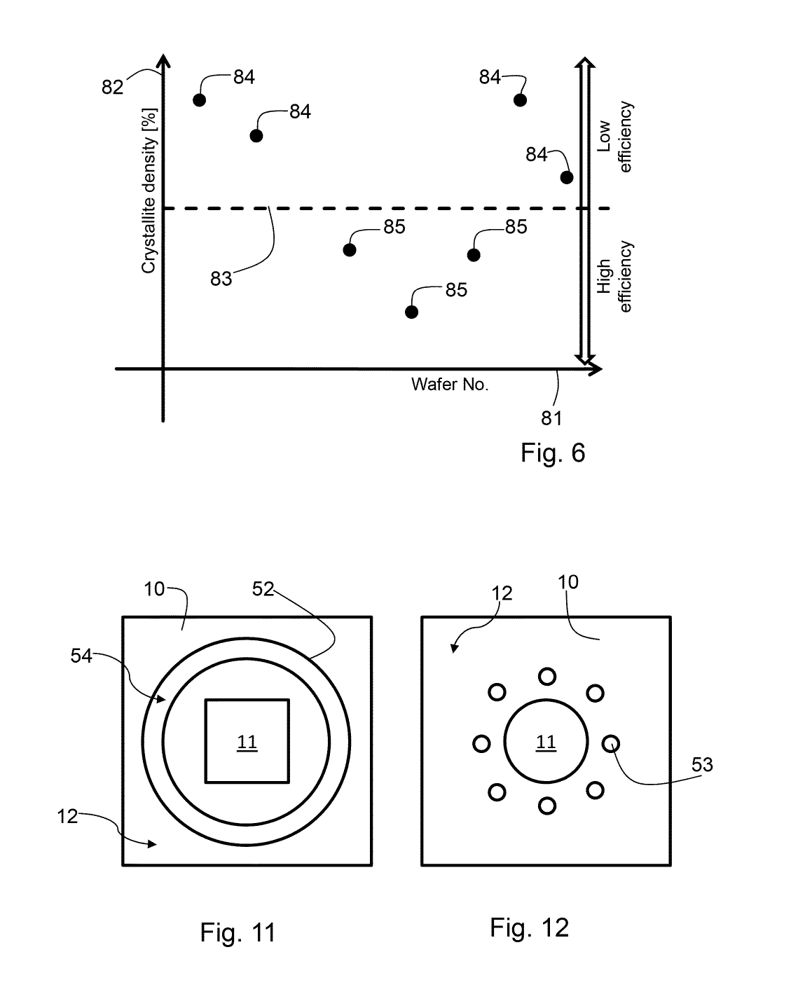

FIG. 6 shows a diagram with various values 84, 85 of the density of crystallite boundaries on surfaces of various wafers. Positions along an abscissa 81 correspond to the various wafers. Positions along an ordinate 82 correspond to values of the density of crystallite boundaries on the surface of the respective wafers. Also shown is a density threshold 83. Such a density threshold 83 may for example be set by a user or obtained from some form of analysis, like statistical analysis. According to an embodiment of the invention, the density threshold 83 is used to classify wafers into high-efficiency wafers and low-efficiency wafers, depending on the value of the density of crystallite boundaries on the surface of the respective wafer 40. Wafers 40 with a corresponding density value 84 above the density threshold 83 are classified as low-efficiency wafers, wafers with a corresponding density value 85 below the density threshold 83 are classified as high-efficiency wafers. Put differently, a density threshold 83 is used to clearly distinguish “mono-like” wafers, which are the high-efficiency wafers, from “real” polycrystalline wafers, which are the low-efficiency wafers. So the distinction between high-efficiency, “mono-like” wafers on the one hand, and low-efficiency, “real” polycrystalline wafers on the other hand, depends on the choice of the density threshold 83, but once a density threshold 83 has been chosen, the distinction can be made unambiguously.

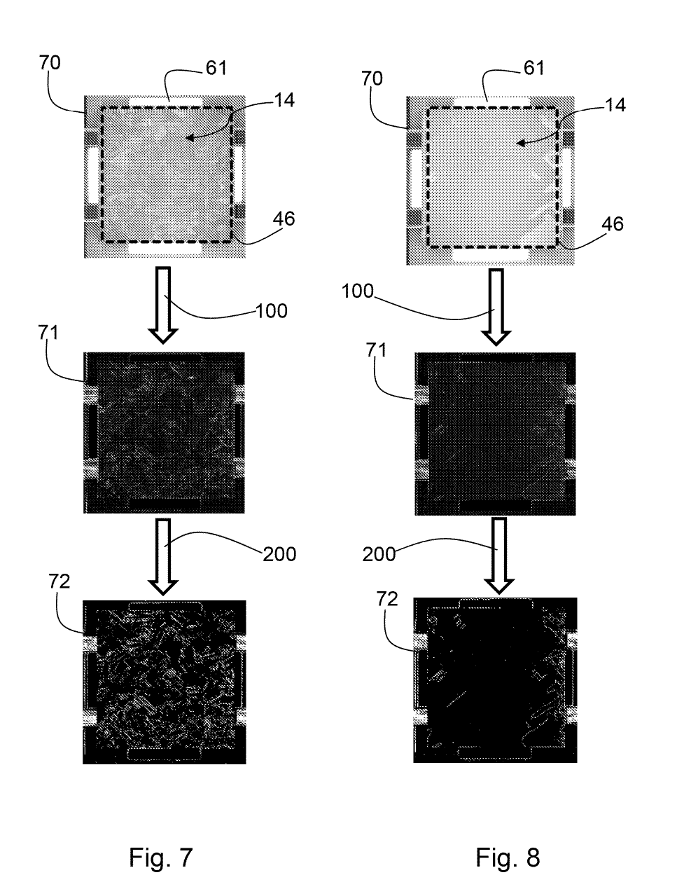

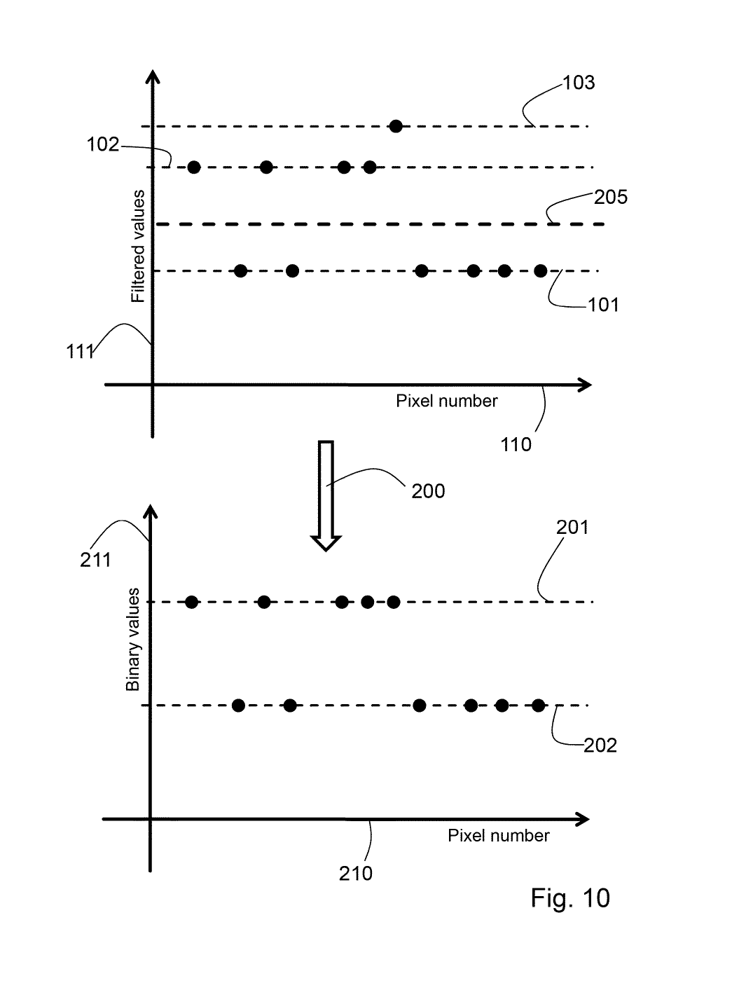

FIG. 7 shows a sequence of a digital image 70 of a surface 41 of a wafer 40 (see FIG. 1) recorded by the camera 20 (see FIG. 1), a filtered image 71 produced from the digital image 70 by a filtering process 100 with a gradient or variance filter, and a binary image 72, obtained from the filtered image 71 by a binarization procedure 200. In the binarization procedure 200, plural, possibly all, pixels of the filtered image 71 are compared with a binarization threshold 205 (see FIG. 10). The binarization threshold 205 may for example be chosen by a user. If a pixel in the filtered image 71 has a value above the binarization threshold 205, a first value 201 (see FIG. 10) is assigned to the corresponding pixel in the binary image 72, otherwise a second value 202 (see FIG. 10) is assigned to the corresponding pixel in the binary image 72. The corresponding pixel in the binary image 72 of a pixel in the filtered image 71 is the pixel in the binary image 72 representing the same location on the surface 41 of the wafer 40 as the pixel in the filtered image 71. In the representation shown, the pixels in the binary image 72 having the first value 201 appear white, the other pixels appear black. The pixels with the first value 201, i.e. here the white pixels, represent the crystallite boundaries. The density of crystallite boundaries on the surface 41 of the wafer 40 can for example be expressed as the ratio of the number of white pixels and the total number of pixels in the binary image 72. In a density expressed in this way, crystal boundaries enter in a weighted fashion; the longer a boundary is, i.e. the more white pixels represent the boundary, the higher the contribution of the boundary to the density.

The wafer 40 under consideration in the context of FIG. 7 is a “real” polycrystalline wafer as defined in the context of FIG. 3. In the binary image 72 of the surface 41 of the wafer 40 a large number of crystallite boundaries (appearing here as white lines), and thus a large number of crystallites, is visible.

FIG. 8 is analogous to FIG. 7, however, here a “mono-like” wafer 40, as introduced in the context of FIG. 4, with a number of crystallite boundaries on its surface 41 is considered, which is considerably lower than the corresponding number of crystallite boundaries of the wafer 40 in FIG. 7. In the case of FIG. 8 there are areas free of crystallite boundaries which are comparable in size to the entire surface of the wafer 40. Of course, terms like “considerably lower” or “comparable in size” are rather vague, but, in case all other conditions and process parameters are identical, a solar cell produced from the wafer of FIG. 8 will have a higher efficiency than a solar cell produced from the wafer of FIG. 7. It therefore is desirable to identify such high-efficiency, mono-like wafers at an early stage of the production process. The methods of the invention in their various embodiments provide ways of achieving this. The possibility of a clear and unambiguous distinction between a “mono-like” wafer and a “real” polycrystalline wafer based on a density threshold has already been discussed in the context of FIG. 6.

Also visible in the images shown in FIGS. 7 and 8, in particular in the digital images 70 of the surface 41 of the wafer 40 are images 61 of the LED bars 51 (see FIGS. 1 and 2); here each LED bar 51 is obviously arranged parallel to one edge 46 of the wafer 40 (rectangular wafer), the LED bars 51, or their images 61, respectively, enclose a rectangular area 14 between them.

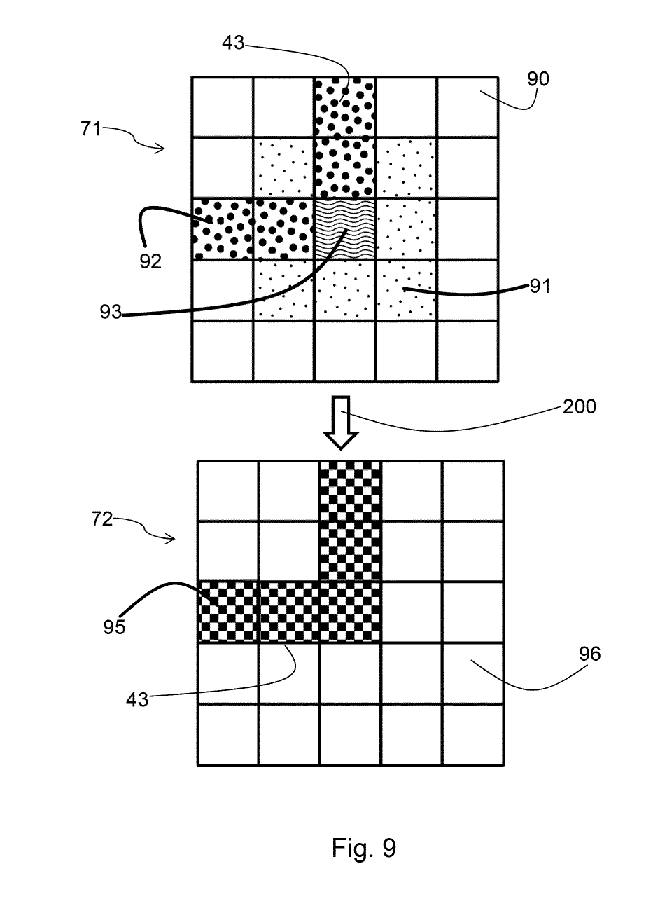

FIG. 9 shows as an example 25 pixels (a 5×5 array) of a filtered image 71 of the surface 41 of a wafer 40, as discussed in the context of FIGS. 7 and 8. Also shown are the corresponding 25 pixels of a binary image 72 generated from the filtered image 71 by a binarization procedure 200 (see also FIGS. 7 and 8). Each pixel of the filtered image 71 represents the value output from a variance or gradient filter, i.e. a filtered value, when generating the filtered image 71 from the digital image 70 (see FIGS. 7 and 8). For purposes of illustration, of the pixels of the filtered image 71 shown, let the pixels 91 (marked by small dots) have a first filtered value, the pixels 92 (marked by large dots) have a second filtered value, and the pixel 93 (marked by a wavy pattern) a third filtered value. Therein the third filtered value is larger than the second filtered value, which in turn is larger than the first filtered value. This implies that the gradient or variance, respectively, in the digital image 70 at the location corresponding to the pixel 93 is higher than the gradient or variance at the locations represented by the pixels 92, which in turn are higher than the gradient or variance at the locations represented by the pixels 91. Furthermore, pixels 90 (unmarked) shall have filtered values below the first filtered value, i.e. the gradient or variance at the locations represented by the pixels 90 is lower than gradient or variance at the locations represented by the pixels 91. As has already been mentioned above, the binarization procedure 200 involves a binarization threshold 205 (see FIG. 10). For the case of FIG. 9, let this binarization threshold 205 be such that the second filtered value of the pixels 92 and the third filtered value of the pixel 93 are above the binarization threshold 205, and the first filtered value of the pixels 91 as well as the filtered values of the pixels 90 are below the binarization threshold 205. As a consequence, in the binarization procedure a first value is assigned to the pixels 95 of the binary image 72 corresponding to the pixels 92 and 93 of the filtered image 71, and a second value is assigned to the pixels 96 of the binary image 72, corresponding to the pixels 90 and 91 of the filtered image 71. In FIG. 9, the pixels 95 of the binary image 72 having the first value are marked with a checkerboard pattern, while the pixels 96 of the binary image 72 having the second value are unmarked. In the 5×5 pixel array shown, the pixels 95 of the binary image 72 having the first value correspond to part of a crystallite boundary 43 on the surface 41 of the wafer 40 the filtered image 71 and binary image 72 are obtained from. In the binary image 72 this crystallite boundary 43 is more clearly delineated, involving only the pixels 95 having the first value, than in the filtered image 71, where it gives rise to a more diffuse structure comprising at least the pixels 91, 92, and 93.

FIG. 10 illustrates how the binary image 72 (see FIGS. 7, 8 and 9) is obtained from the filtered image 71 (see FIGS. 7, 8 and 9). In the top diagram in FIG. 10, positions along an abscissa 110 correspond to a pixel number, uniquely identifying a pixel in a given digital image 70 (see FIGS. 7 and 8), and positions along an ordinate 111 correspond to filtered values obtained by the filtering procedure 100 (see FIGS. 7 and 8), which generated the filtered image 71 from the digital image 70, for the respective pixels. The unique pixel number may be assigned to the pixels in an arbitrary fashion, for example by counting the pixels in the image in a row-wise or column-wise fashion and assigning to each pixel its corresponding number in the count. Also shown in the top diagram of FIG. 10 is a binarization threshold 205, a first filtered value 101, which is below the binarization threshold 205, a second filtered value 102, which is above the binarization threshold 205, and a third filtered value 103, which is larger than the second filtered value 102. For purposes of illustration also several data values (black dots) are shown, which here correspond to the pixels of the filtered image 71 of FIG. 9. The data values equal to the first filtered value 101 correspond to the pixels 91 in the filtered image 71, the data values equal to the second filtered value 102 correspond to the pixels 92 in the filtered image 71, and the data value equal to the third filtered value 103 corresponds to the pixel 93 in the filtered image 71. Filtered values corresponding to pixels 90 in the filtered image 71 of FIG. 9 are not shown for the sake of clarity. The fact that several filtered values in the top diagram are equal is due to our choice of illustrative example, i.e. the filtered image 71 shown in FIG. 9, and no restriction of the invention whatsoever.

By the binarization procedure 200, the filtered values of the filtered image 71 are converted to values of a binary image 72 (see FIG. 9). In the bottom diagram of FIG. 10, positions along an ordinate 211 correspond to values in the binary image 72 (binary values) of FIG. 9, of which, of course, there are only two in a binary image, a first value 201 and a second value 202, whereas positions along an abscissa 210 correspond to the same unique pixel numbers as the corresponding positions along the abscissa 110 in the top diagram. According to the binarization procedure 200, filtered values above the binarization threshold 205 are converted to the first value 201, and filtered values below the binarization threshold 205 are converted to the second value 202 in the binarization procedure 200. Specifically in the case of FIG. 10 this implies that data values of the filtered image 71, equal to, as shown in the top diagram of FIG. 10, the second filtered value 102 or the third filtered value 103, are mapped to the first value 201 by the binarization procedure 200, whereas the data values of the filtered image 71 equal to the first filtered value 101 are mapped to the second value 202 by the binarization procedure 200.

FIG. 11 shows an alternative embodiment of an aperture plate 10 and illumination system. The aperture plate 10 has an aperture 11, which here is square as in the case of the aperture plate of FIG. 2. The illumination system here is given by a ring light illuminator 52, which in this embodiment has a continuous ring-shaped light-emitting surface 54. The ring light illuminator 52 is provided on a side 12 of the aperture plate facing away from the camera 20 (see FIG. 1).

FIG. 12 shows an alternative embodiment of an aperture plate 10 and illumination system. The aperture plate 10 has an aperture 11, which here is circular. The illumination system is given by a ring light illuminator, which in this embodiment is an annular arrangement of light sources 53. The light sources 53 are provided on a side 12 of the aperture plate 10 facing away from the camera 20 (see FIG. 1).

From FIGS. 2, 11, and 12 it is evident that in all these embodiments the illumination system is arranged coaxial with the aperture 11, and thus coaxial with the imaging path 21 (see FIG. 1). Furthermore, the aperture 11 is not restricted to square or circular shape, but may also be shaped as a general polygon, of which a rectangle, a hexagon, and an octagon are specific examples. The aperture 11 may also be elliptical, for example. In specific embodiments, the illumination system may be adapted in shape to the shape of the aperture, for example a ring light illuminator for a circular aperture, as is the case in FIG. 12, or a rectangular arrangement of light sources for a rectangular aperture, as shown for example in FIG. 2 for the case of a square aperture. The correspondence in shape of aperture and illumination system is not necessary, however, as shown for example in the case of FIG. 11, where a ring light illuminator is used with a square aperture.

In the representation of FIG. 1 the imaging path 21 is straight. It is obvious to a person skilled in the art, however, that in different embodiments the imaging path may consist of plural segments of different orientation. Likewise, light beams from the illumination system may be redirected once or several times on their way to the surface 41 of the wafer 40. For the invention it is relevant that the illumination from the illumination system is coaxial with the imaging path 21 at least upon incidence on the surface 41 of the wafer 40, wherein the imaging path 21 is parallel to the normal 44 of the surface 41 of the wafer 40 at least at a segment of the imaging path 21 in contact with the surface 41 of the wafer 40. Coaxial illumination is achieved with an illumination system coaxial with the aperture 11, for example, but also for any other optical arrangement wherein an arrangement of light beams from the illumination system is coaxial with the imaging path 21.

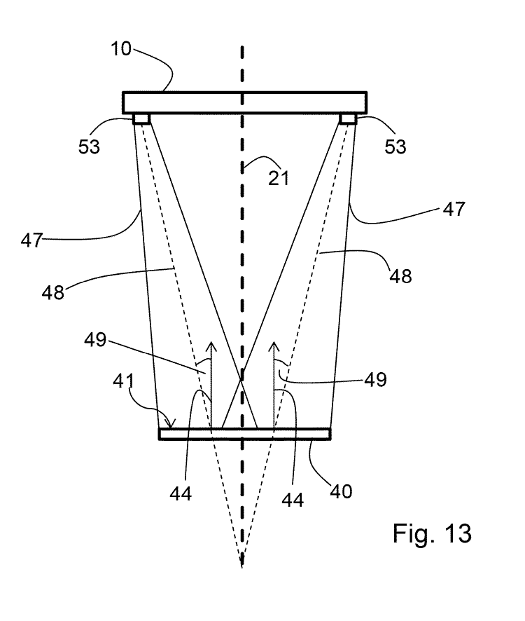

FIG. 13 shows an aperture plate 10 with light sources 53. Only two light sources 53 are shown for the sake of clarity, but the aperture plate 10 may exhibit more than two light sources, as also evident from FIGS. 2 and 12. Each light source 53 emits a light cone 47 incident on a surface 41 of the wafer 40. A normal 44 of the surface 41 of the wafer 40 is shown twice at different locations of the surface 41 of the wafer 40 for the purpose of illustration. For each light cone 47 a center line 48 is shown. The normal 44, shown at the appropriate location where the respective center line 48 intersects the surface 41 of the wafer 40, encloses an angle 49 with the center line 48 in each case. In embodiments, the angle 49 is between 0 degrees and 30 degrees, and preferentially is between 10 degrees and 20 degrees.

Also shown in FIG. 13 is the imaging path 21. The imaging path 21 and the center lines 48 are shown extended beyond the surface 41 of the wafer 40 to illustrate that the illumination of the surface 41 is coaxial with the imaging path 21. That is, the imaging path 21 coincides with a symmetry axis of the arrangement of the light cones 47, more precisely of the center lines 48 of the light cones 47. The extension of imaging path 21 and center lines 48 beyond the surface 41 of the wafer 40 is for purposes of illustration only, and does not indicate that light from the light sources 53 is or needs to be transmitted through the wafer 40.

The invention has been described with reference to specific embodiments. It is obvious to a person skilled in the art, however, that alterations and modifications can be made without leaving the scope of the subsequent claims.

### REFERENCE NUMERALS

1 apparatus
8 illumination system
10 aperture plate
11 aperture
12 side of aperture plate facing away from the camera
13 side of aperture
14 rectangular area
20 camera
21 imaging path
30 image processing unit
40 wafer
41 surface of wafer
42 crystallite
43 crystallite boundary
44 normal of surface of wafer
46 edges of wafer
47 light cone
48 center line of light cone
49 angle
51 LED bar
52 ring light illuminator
53 light source
54 light-emitting surface
61 image of LED bar
70 digital image
71 filtered image
72 binary image
81 abscissa
82 ordinate
83 density threshold
84 density value
85 density value
90, 91, 92, 93 pixel of filtered image
95, 96 pixel of binary image
100 filter procedure
101 first filtered value
102 second filtered value
103 third filtered value
110 abscissa
111 ordinate
200 binarization procedure
201 first value
202 second value
205 binarization threshold
210 abscissa
211 ordinate

What is claimed is:

1. A method for estimating an efficiency of a solar cell to be manufactured from a wafer during a production process, comprising the following steps:
identifying crystallite boundaries on a surface of the wafer;
deriving a density of crystallite boundaries on the surface of the wafer; and
obtaining an efficiency estimate from the density of crystallite boundaries.

2. The method of claim 1, wherein the efficiency estimate is obtained by classifying the wafer as a high-efficiency wafer, if the density of crystallite boundaries is below a density threshold, and classifying the wafer as a low-efficiency wafer, if the density of crystallite boundaries is above the density threshold.

3. The method of claim 1, wherein the efficiency estimate is obtained from a look-up table, wherein the look-up table is pre-generated from a sample set of solar cell efficiency values and corresponding densities of crystallite boundaries.

4. The method of claim 1, wherein the efficiency estimate is obtained by calculating a value for the efficiency from the density of crystallite boundaries according to a polynomial function, wherein the polynomial function is derived from a sample set of solar cell efficiency values and corresponding densities of crystallite boundaries.

5. The method according to claim 1, wherein the density of crystallite boundaries is expressed as a number of crystallite boundaries per unit area.

6. The method according to claim 1, wherein the density of crystallite boundaries is expressed as total length of crystallite boundaries per unit area.

7. The method of claim 1, wherein identifying the crystallite boundaries on the surface of the wafer comprises taking a digital image of the surface of the wafer.

8. The method of claim 7, wherein identifying the crystallite boundaries on the surface of the wafer further comprises applying a gradient filter or a variance filter to the digital image, thus generating a filtered image.

9. The method of claim 8, wherein identifying the crystallite boundaries on the surface of the wafer comprises the further step of binarizing the filtered image, thus generating a binary image, wherein binarizing is achieved by comparing, for a plurality of pixels of the filtered image, the value of a respective pixel with a binarization threshold, and assigning a first value to a corresponding pixel of the binary image, if the value of the respective pixel in the filtered image is above the binarization threshold, and assigning a second value to the corresponding pixel of the binary image otherwise.

10. The method of claim 9, wherein the density of crystallite boundaries is expressed as a ratio of the number of pixels in the binary image having the first value and the total number of pixels representing the surface of the wafer.

11. The method of claim 7, wherein the digital image of the surface of the wafer is taken by illuminating the surface with light from an illumination system, and light from the illuminated surface is directed to a camera along an imaging path, wherein the illumination system is arranged coaxial to the imaging path.

12. The method of claim 11, wherein light from the illumination system encloses an angle of 0 degrees to 30 degrees, and preferably of 10 degrees to 20 degrees, with a normal of the surface of the wafer.

13. A method for estimating an efficiency of a solar cell to be manufactured from a wafer during a production process, comprising the following steps:
identifying crystallites on a surface of the wafer;
determining a size for each identified crystallite, thus generating a list of sizes;
obtaining an efficiency estimate of the solar cell as a function of the list of sizes determined in the previous step.

14. The method of claim 13, wherein a set of a number N of largest crystallites is identified, the number N is set by a user or the number N is determined automatically by selecting all crystallites larger than a predefined absolute size or a set percentage of the total wafer size.

15. The method of claim 13, wherein the function of the list of sizes is given as a function of the sum of the sizes.

16. The method of claim 13, wherein identifying the crystallites and determining their sizes comprises the steps of
obtaining a digital image of the surface of the wafer;
establishing for each identified crystallite the number of pixels representing the respective crystallite in the digital image.

17. The method of claim 16, wherein the digital image of the surface of the wafer is taken by illuminating the surface with light from an illumination system, and light from the illuminated surface is directed to a camera along an imaging path, wherein the illumination system is arranged coaxial to the imaging path.

18. The method of claim 17, wherein light from the illumination system encloses an angle of 0 degrees to 30 degrees, and preferably of 10 degrees to 20 degrees with a normal of the surface of the wafer.

19. The method of claim 17, wherein the illumination system comprises plural light sources which are activated simultaneously in order to record a digital image of the surface of the wafer.

20. The method of claim 17, wherein the illumination system comprises plural light sources, the light sources are activated as a function of time in a sequence of predefined patterns, and a digital image is recorded for at least one predefined pattern of activated light sources.

21. The method of claim 20, wherein the illumination system comprises four groups of light sources, each group of light sources contains at least one light source, the groups are aligned such that each group corresponds to one side of a rectangular area parallel to the surface of the wafer, and the sequence of predefined patterns is such that the groups of light sources are activated successively.

22. The method of claim 20, wherein a gradient or a variance filter is applied to each recorded digital image.

23. The method of claim 20, wherein a digital image is recorded for each of a plurality of patterns of activated light sources, and the digital images are combined into a single resulting image by data processing.

24. The method of claim 20, wherein a digital image is recorded for each of a plurality of patterns of activated light sources, a gradient or a variance filter is applied to each recorded digital image, thus generating a filtered image for each recorded digital image, and the filtered images are combined into a single resulting image by assigning to each pixel of the resulting image the maximum of the values of the corresponding pixels in the filtered images, or the sum of the values of the corresponding pixels in the filtered images, or the average of the values of the corresponding pixels in the filtered images.

25. The method of claim 13, wherein only crystallites are taken into account which exhibit surfaces oriented according to the <100> Miller index within a predefined tolerance at the surface of the wafer.

26. The method of claim 25, wherein the crystallites to be taken into account are identified due to the reflection characteristics of the surface of crystallites oriented according to the <100> Miller index, the reflection characteristics of a given crystallite surface being determined using the illumination system and the camera.

27. The method of claim 25, wherein a gray value for the largest crystallite taken into account is determined and all further crystallites with a gray value within 15%, and preferably within 3% of the total gray range available of the gray value for the largest crystallite are taken into account.

28. The method of claim 25, wherein the crystallites to be taken into account are identified by determining a number K of crystallites with the lowest gray values, identifying the largest crystallite of these K crystallites and identifying its gray level G as the average or median gray value of its surface, and taking into account all crystallites with a gray value within a tolerance ΔG from the gray level G of the identified largest crystallite, wherein the tolerance ΔG is 15%, and preferably 3%, of the total gray level range possible.

29. The method of claim 28, wherein K is set by a user or determined automatically by selecting all crystallites with a gray level below a predefined gray level.

30. The method of claim 25, wherein of pairs of connected crystallites, each member of the pair exhibiting a surface oriented according to the <100> Miller index within a predefined tolerance at the surface of the wafer, one member is disregarded.

31. The method of claim 30, wherein the member disregarded is the smaller or brighter member of the pair.

32. The method of claim 13, wherein the efficiency estimate is obtained from a look-up table, wherein the look-up table is pre-generated from a sample set of solar cell efficiency values and corresponding lists of sizes.

33. The method of claim 13, wherein the efficiency estimate is obtained by calculating a value for the efficiency from the list of sizes according to a polynomial function, wherein the polynomial function is derived from a sample set of solar cell efficiency values and corresponding lists of sizes.

34. The method of claim 33, wherein the polynomial function depends on as many variables as there are elements in the list of sizes.

35. The method of claim 13, wherein the sizes of crystallites which exhibit surfaces oriented according to the <100> Miller index within a predefined tolerance at the surface of the wafer are determined separately from the sizes of crystallites with different orientation and/or wherein a density of crystallite boundaries is determined in addition to a determination of the sizes of the crystallites, and an efficiency estimate of the solar cell is obtained as a function of the data thus determined.

36. A method for estimating an efficiency of a solar cell to be manufactured from a wafer during a production process, comprising the following steps:
identifying a first group of crystallites, where the first group comprises crystallites with crystallite surfaces oriented according to the <100> Miller index within a predefined tolerance at the wafer surface, and a second group of crystallites, where the second group comprises crystallites with crystallite surfaces not oriented according to the <100> Miller index within the predefined tolerance at the wafer surface;
deriving an area of the crystallite surfaces of the crystallites in the first group or in the second group; and
obtaining an efficiency estimate from the area derived in the previous step.

37. Apparatus for estimating an efficiency of a solar cell to be manufactured from a wafer during a production process, comprising:
a camera configured to capture an image of the surface of the wafer, wherein the camera defines an imaging path;
an illumination system configured to illuminate the surface of the wafer, wherein the illumination system is arranged coaxial to the imaging path;
an image processing unit, configured to process an image of the surface of the wafer captured by the camera and to derive an efficiency estimate for a solar cell to be manufactured from the wafer from the image.

38. The apparatus of claim 37, wherein the illumination system comprises a ring light illuminator.

39. The apparatus of claim 37, wherein the illumination system comprises plural LED bars as light sources.

40. The apparatus of claim 39, wherein the illumination system comprises four LED bars, which are arranged in such a way that they include a rectangular area between them.

41. The apparatus of claim 40, wherein the apparatus exhibits an aperture plate with a rectangular aperture, and the LED bars are arranged around the aperture on a side of the aperture plate facing away from the camera.

42. The apparatus of claim 41, wherein the apparatus is configured such that the rectangular aperture is adapted in shape to a rectangular wafer to be imaged by the camera, and wherein the LED bars are aligned around the aperture in such a way that during imaging of the surface of the wafer each side of the surface of the wafer is parallel to one LED bar.

43. The apparatus of claim 37, wherein to the apparatus there corresponds a set of aperture plates, each aperture plate exhibiting an aperture which differs in size and/or shape from the apertures of the other aperture plates, and wherein the illumination system is arranged around the aperture on a side of the aperture plate facing away from the camera.

44. The apparatus of claim 43, wherein the shape of the illumination system is adapted to the shape of the aperture.

45. Apparatus for estimating an efficiency of a solar cell to be manufactured from a wafer during a production process, comprising:
a digital camera configured to capture an image of the surface of the wafer, wherein the camera defines an imaging path;
four LED bars arranged and configured to illuminate the surface of the wafer, wherein the LED bars are arranged on an aperture plate coaxial to the imaging path; and
an image processing unit, configured to process an image of the surface of the wafer captured by the camera and to derive an efficiency estimate for a solar cell to be manufactured from the wafer from the image.

46. The apparatus of claim 45, wherein the aperture plate has a rectangular aperture adapted in shape to a rectangular wafer to be imaged by the camera, and wherein the LED bars are positioned around the aperture so that the LED bars face away from the camera and are parallel to each edge of the wafer.
